(19) United States
(12) Patent Application Publication
(10) Pub. No.: US 2022/0173910 A1
(43) Pub. Date: Jun. 2, 2022

(54) REMOTE COMMANDS

(71) Applicant: Hewlett-Packard Development Company, L.P., Spring, TX (US)

(72) Inventors: Joshua Serratelli Schiffman, Bristol (GB); Thalia Laing, Bristol (GB); Valiuddin Ali, Bristol (GB); Gaëtan Wattiau, Bristol (GB)

(73) Assignee: Hewlett-Packard Development Company, L.P., Spring, TX (US)

(21) Appl. No.: 17/416,533

(22) PCT Filed: Aug. 16, 2019
(86) PCT No.: PCT/US2019/046779

§ 371 Date: Jun. 21, 2021

(51) Int. Cl. H04L 9/32; G06F 21/64; H04W 12/04; H04W 12/06; H04L 9/40

(52) U.S. Cl. CPC H04L 9/3247; G06F 21/64; H04L 63/101; H04W 12/06; H04W 12/04

(57) ABSTRACT

In an example there is provided a method of issuing a command. A request is received from a device in a set of registered devices, the request comprising a command for execution at a remote device. The request is communicated to the set of registered devices. A response to the request is received from each device in a subset of the set of registered devices. A further request to execute the command, is communicated to the remote device on the basis of the responses. The command executes on the remote device when the subset of devices is an authorised subset of the registered devices.

### BACKGROUND

Modern networked devices connect to cloud-based services through the internet. Devices may be managed via a device management service. Device management services may be operated by the device manufactures. Device management services configure, provision and update devices which are under management over the network. Administrators of cloud-based services issue requests to the device management service to initiate the execution of commands on devices remotely. This provides administrators with the powers to efficiently execute management operations on devices at scale without having to be physically present at the devices.

### BRIEF DESCRIPTION OF THE DRAWINGS

FIG. 1 schematic diagram showing an apparatus for executing a command on a remote device, according to an example.

FIG. 2 is a block diagram showing a method of issuing a command, according to an example.

FIG. 3 shows a processor associated with a memory comprising instructions for issuing a command on a computing device.

### DETAILED DESCRIPTION

In cloud-oriented computing environments users remotely connect their devices across a network to access services and data. In some scenarios, administrators may wish to push updates or execute commands on devices. Device management services are services operated by device manufactures or third parties that manage potentially millions of devices. Device management services are able to provision, configure, and update endpoint devices at scale.

Remote management commands are used by management services to remotely configure devices in the field without having to send a person to the device. Operations like remotely wiping a device, changing settings, locking a device, or installing updates may be performed remotely. The device management service provides a platform through which authorised administrators can issue commands to endpoint user devices efficiently and at scale.

Management services implement cryptographic protocols to ensure that commands are issued at the request of legitimate administrators. An administrator authenticates themselves via an identity management service such as Active Directory (AD). Once authenticated, the administrator instructs the management service to issue commands. The commands are digitally signed by the management service using a cryptographic signature scheme. Commands may be distributed to individual endpoint devices or groups of devices. Endpoint devices verify the authenticity of the signed commands using pre-distributed public keys and execute the commands when the signatures verify successfully.

There are a number of security concerns with using such a method to issue commands from an authorised service. Attacks on such a system can lead to the compromise of potentially millions of user devices. A single administrator authorised to use the management service can issue malicious commands if they choose to or if their credentials are stolen. Moreover, a compromised service can bypass the administrator's authorisation and use the service's private signing key to issue malicious commands. A compromised management service can bypass the authentication process and launch malicious attacks against endpoint devices directly from the service.

Methods and systems described herein use distributed signature schemes to eliminate the points of failure. In general, in a digital signature scheme a public and private key pair are generated for a user. The public key is publicly known, and the private key is kept private by the signer. When the signer wants to sign a message to provide integrity and data origin authentication on the message, they use the private key to sign the message or a fingerprint of the message and output the signature. A verifier can then use the public key and verify that the signature was generated by the owner of the private key.

Distributed signature schemes differ from signature schemes between a single signer and verifier, in that the private key is distributed according to an access structure amongst a set of signers. The public key, in general is unchanged. The access structure defines a set of authorised subsets of signers. Any authorised subset of signers according to the access structure may generate a valid signature by each signer generating partial signatures which are combined to form the full signature.

One example of an access structure is a threshold access structure. In a threshold access structure, authorised subsets are defined as those subsets comprising at least T out of a total of a group of size N. In a threshold signature scheme, the full signature may be constructed from a subset of T partial signatures for a threshold T. Many existing signature schemes such as the Digital Signature Algorithm (DSA) or Elliptic Curve Digital Signature Algorithm (ECDSA) have equivalent threshold schemes. In a threshold signature scheme, the initial sharing of the private signing key, run during set-up, can either be done by a trusted dealer, or by the signers themselves in a distributed manner. Most threshold signature schemes can be constructed with either a trusted dealer or with a distributed dealer.

In methods and systems described herein the management service first defines an access structure. The service then generates a public and private key pair comprising a private signing and public verification key. A set of key shares is created by distributing the signing key to authorised administrator devices. The public verification key is sent to the devices under management. In order to issue a command, a request to execute the command issued by one of the administrators is sent to the service, which forwards the request to the other authorised administrators. The request is partially signed by a subset of authorised administrators. The management service forwards the request to the devices under management to execute the command. Optionally, the management service may block or log requests for audit, before distributing to the managed devices. Upon receipt, the devices can assemble the partial signatures into a fully signed command, verify the signature using their verification key, and perform the requested operation.

Methods and system described herein enable the enforcement of an authorization workflow that is resilient to failures or compromises of the admins or management service. Methods are applicable to many kinds of device management services. In particular, it provides a secure method for implementing services that may be vulnerable to insiders and rogue employees or distributed service architectures that rely on potentially untrusted hosting services for the management of cryptographic keys.

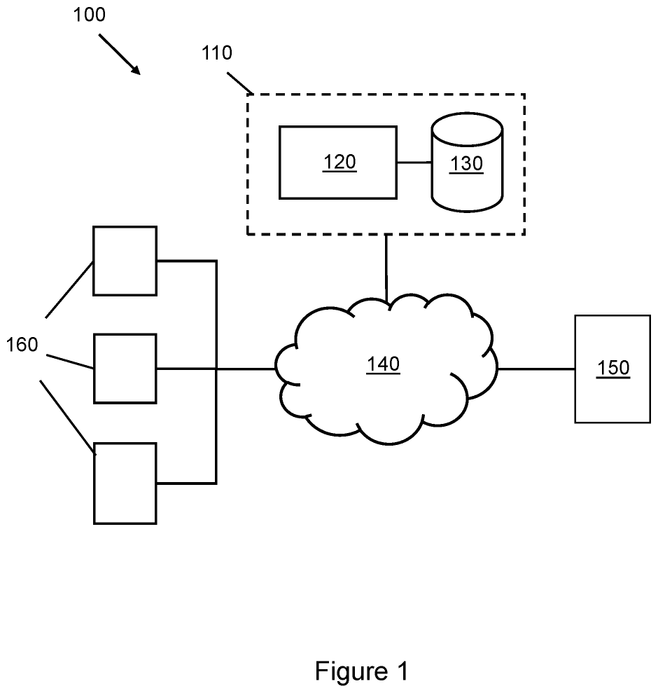

FIG. 1 shows a simplified schematic diagram of an apparatus 100 for issuing a command according to an example. The apparatus 100 may be used in conjunction with methods and other systems described herein.

The apparatus 100 shown in FIG. 1 comprises a management service 110. The management service 110 may be instantiated as a cloud service, an on-premise server, or any form of service architecture. The management service 110 comprises a management module 120. The management module 120 may be implemented in software or hardware or a combination of both software and hardware. In examples described herein, the management module 120 is capable of cryptographic operations and protecting secrets or has access to resources that are trusted to do this. The management module 120 is communicatively coupled to a data storage 130. In FIG. 1, the data storage 130 is shown as being comprised in the management service 110. In some examples, the management service 110 may access data held remotely from the management module 110.

In FIG. 1, the management service 110 is in communication with other entities via a network 140. According to examples, the network 140 may be a private local area network (LAN) or a public network such as the internet. The management service 110 is in communication with a remote device 150. The remote device 150 may be an endpoint user device such as a mobile device or desktop computing device. In other cases, the device 150 may be a printer, a server or an internet-of-things (IoT) smart device.

In FIG. 1 a single remote device 150 is shown. In real-world scenarios potentially millions of remote devices are in communication with the management service 110 over the network 140.

Commands are issued from the management module 120 in the management service 110 to the remote device 150 over the network 140. Commands that may be issued to the remote device 150 include: remotely wiping the device 150, changing settings on the device 150, locking the device 150, causing the device 150 to wake up or shut down, or installing updates on the device 150.

According to examples described herein, the remote device 150 comprises a trustworthy management component able to perform administrative operations on the device. The specification of the level of the component varies depending on the scenario and security level. For example, operations like wiping a hard disk, locking the device from booting, and changing critical settings use a very secure component because the consequences of an unauthorised party performing the operation on the device are severe. In all cases however the components of the remote device 150 are able to authenticate the issuer of the command before accepting and performing the request.

The apparatus 100 comprises administrator devices 160. The administrator devices 160 are in communication with the management service 110 over the network 140. According to examples described herein the administrator devices 160 may register with the management service 110. Once administrator devices 160 register with the service 110, they may issue requests for commands to be executed on the remote device 150, according to examples described herein.

In some cases, in an initial set up phase, administrator devices 160 are given credentials which allow them to authenticate at a later date with the management service 110. According to examples described herein the management module 120 is arranged to maintain a list of registered administrator devices 160 in the data storage 130. As part of maintaining the list, the management module may add or remove devices 160 from the list of authorised devices.

In examples described herein the management service 110 may issue devices 160 with cryptographic keys. In some cases, the management service 110 comprises a key management module arranged to manage cryptographic key material. The key management module may be communicatively coupled to the data storage 130.

The key management module is arranged to generate a cryptographic signing and public verification key. In one case, the management service 110 distributes the public key to the remote device 150. The management service 110 generates shares of the secret signing key and distributes the shares to the registered administrator devices 160. In some cases, the shares are communicated to the registered devices 160 using public key cryptographic techniques, via the network 140.

In examples described herein, the data storage 120 stores a list of the registered devices 160 together with an access structure F. Let D={d₁, d₂, . . . , dₙ} denote the set of registered devices 160. An access structure F is a set consisting of all subsets of D which are authorised to send commands to the remote devices.

According to examples described herein, the access structure F may consist of all subsets of D which contain t or more devices, where t is a constant threshold number less than the total number of devices. This threshold may be n/2, for example. Thus, for example, if the management service 110 implements a n/2-threshold signature scheme then the partial shares of the secret signing key which the registered devices 160 possess allow any group of n/2 or more administrators to generate partial signatures which may be combined to generate a full signature. In other examples, the threshold is a fixed value which does not depend on n, the number of authorised administrators. In that case, the number of administrators may be increased or decreased without the threshold changing.

In some examples, the management module 120 is arranged to combine partial signatures to generate full signatures on requests received from the registered devices 160. In other examples, the remote device 150 may be arranged to combine partial signatures on requests received from the registered devices 160.

According to examples described herein, the authorisation of a management command by the management service 110 proceeds as follows: a public key pair is generated and distributed among the registered devices 160 such that each registered device 160 has a partial public key and a partial secret signing key share. The distribution is done in such a way that authorised subsets according to the access structure stored in data storage 120, can create a valid signature. In examples this may be achieved using threshold cryptography.

The public verification key is given to the remote device 150, possibly along with a certificate ensuring the public key is valid, by the management service 110.

An administrator logs into the management service 110 via their device 160 over the network 140, and issues a management command for a set of devices including the remote device 150. In examples described herein, the request includes a request to execute command (C) a random challenge (R) for freshness, and the set of remote devices (D). The request is partially signed using the device's partial secret key (AK). For example, the device may send
Request=<C, R, D, sign(C∥R∥D, AK)>

In some examples, other information may be sent and potentially signed along with the challenge, such as an identifier of the machine being targeted, the UUID, serial number, a timestamp including the date and time the request was made, and an identifier such as the email or verification key of the admin requesting the command. In some examples, some of this information may be encoded into the challenge.

The management service 110 communicates the request to the other registered devices 160 via the network 140. In examples described herein, this could be done through email to each of the registered devices 160. Alternatively, the administrators may be alerted to the request and told to log into the management service 110 to see it.

If the other administrators agree to the request, they respond to the management service 110 by producing a partial signature using their device 160 on the challenge with their partial secret key.

In some examples, the management module 120 may be arranged to access the data storage 130 to determine if the subset of the devices 160 that have communicated partial signatures to the management service 110 is an authorised subset. In other cases, no such determination is made. The management service 110 forwards the partial signatures and the challenge to the remote device 150.

In some examples an optional approval maybe included whereby the management service 110 blocks undesirable commands or partial signatures by revoked admins. Additionally, in some cases, the management service 110 signs the request to indicate its own approval. This may be done with a separate public key pair. In another example, the request is sent off to a different entity to approve the command.

The remote device 150 is arranged to combine the partial signatures received from the management service 110. The combining process does not need any private information to be input by the remote device 150. When the partial signatures have been combined to produce a complete signature, the device 150 verifies the complete signature using the public key they were given during the setup procedure.

If the signature received successfully verifies, the device 150 executes the command. In some examples, the device stores the challenge and the list of partial signatures received in a location that is accessible in the future, then executes the command. The partial signatures may be stored for auditing purposes. For example, the list of partial signatures, and an association between commands issued, and the devices which sent the commands may be stored by the management service 110. A registered device 160 can query the management service to identify which administrator sent a particular request.

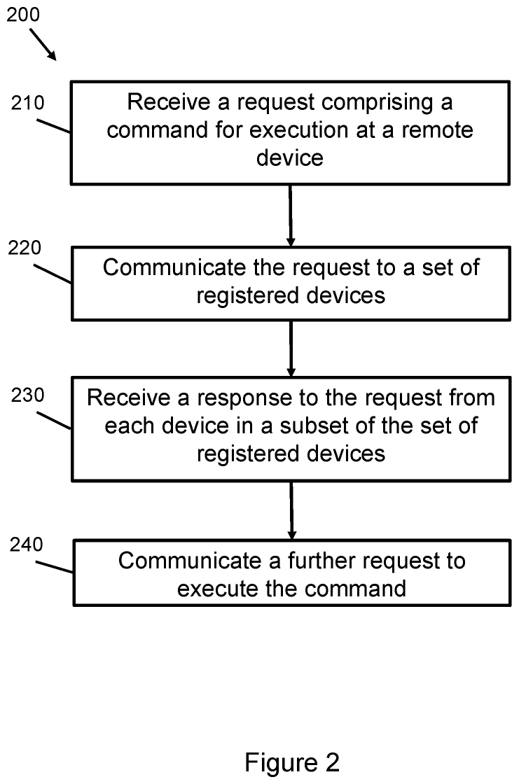

FIG. 2 is a block diagram showing a method 200 for issuing a command, according to an example. The method 200 shown in FIG. 2 may be implemented on the apparatus 100 shown in FIG. 1 to issue a command to the device 150. In particular, the method 200 may be implemented on the management service 1100 shown in FIG. 1.

At block 210, a request is received comprising a command for execution at a remote device. When the method 200 is implemented on the apparatus 100 shown in FIG. 1, the request is received from one of the registered devices 160.

According to examples, the method 200 may further comprise determining whether a received request is sent from a device on a list of registered devices. When the request is received from a device which is not on the list, the method 200 may further comprise blocking the request.

At block 220, the request is communicated to a set of registered devices. In the context of apparatus 100 shown in FIG. 1, the request is communicated to the other administrator devices 160. The request may be communicated in the form of a notification to the registered devices. In some examples, the notification is in the form of a communication such as an e-mail.

At block 230, a response is received to the request from each device in a subset of the set of registered devices. According to examples, the method 200 may comprise determining whether a response is from a registered device and blocking the response when the response is received from a device which is not from a registered device.

At block 240, a further request is communicated to execute the command of the original request. The further request to execute the command may be communicated directly to the remote device or to a third party, which forwards the command after performing verification operations on the further request. The request executes on the remote device when the subset of devices is an authorised subset, according to an access structure.

According to examples described herein, the further request may be processed by the remote device to execute the command. Processing the further request, in some cases, comprises performing verification of the command and determining that the request originated at the entity that implements method 200.

In some examples the method 200 may comprise generating and storing cryptographic keys. In particular, the method 200 may comprise, generating a cryptographically secure signing key and verification key. The signing key is a private key. The method 200 may comprise generating partial signing keys on the basis of the signing key and distributing the partial signing keys to the set of registered devices.

According to examples, the original request may comprise a partial signature generated on the basis of a challenge and the partial signing key of the device which sent the request. The responses to the request may comprise a partial signature received from each device, generated on the basis of the partial signing keys of each device and challenge. In that case the further request which is sent to the remote device may comprise the partial signatures of the subset of the devices, the challenge and the command.

In some cases, the method 200 comprises, receiving the further request, generating a signature on the basis of the partial signatures, verifying the signature on the basis of the verification key and executing the command at the remote device when the signature is successfully verified.

This methods and systems described herein enhance security in systems in which commands are issued remotely to devices. These methods may be used to protect workflows from compromise and single points of failure.

Examples of methods and systems described herein provide strong cryptographic assurances and guarantees. In contrast to systems where a single administrator can generate valid signatures on their own request, methods and systems herein are based on a quorum of authorised administrators that generate partial signatures before a remote command is issued to a device. This prevents a malicious administrator using the management service to issue destructive commands or an attacker that steals the administrator's commands impersonating the administrator to issue malicious commands.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. Methods and modules may all be performed by a single processor or divided amongst several processors.

Such machine-readable instructions may also be stored in a computer readable storage that can guide the computer or other programmable data processing devices to operate in a specific mode.

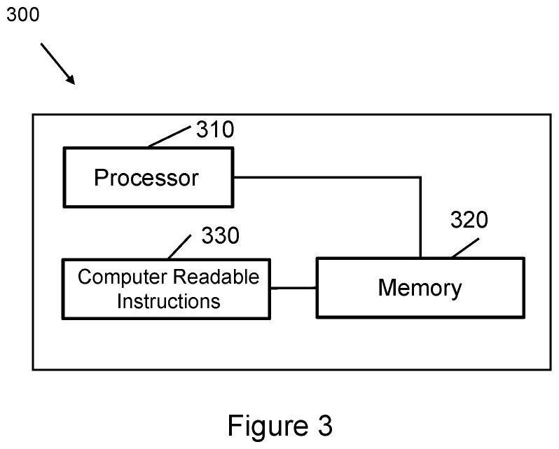

For example, the instructions may be provided on a non-transitory computer readable storage medium encoded with instructions, executable by a processor. FIG. 3 shows an example of a processor 310 associated with a memory 320. The memory 320 comprises computer readable instructions 330 which are executable by the processor 310. The instructions 330 cause the processor to communicate a request comprising a command for execution at a remote device to a set of registered devices. The instructions further cause the processor to process a response to the request from each device in a subset of the set of registered devices and generate a further request to execute the command. The further request is communicated to the remote device. The command executes on the remote device when the subset of devices is an authorised subset of the registered devices

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for issuing a command, the method comprising:
receiving a request from a device in a set of registered devices, the request comprising a command for execution at a remote device;
communicating the request to the set of registered devices;
receiving a response to the request from each device in a subset of the set of registered devices; and
communicating a further request to execute the command, on the basis of the responses, wherein the command executes on the remote device in response to the subset of devices being an authorised subset of the registered devices.

2. The method of claim 1, comprising:
generating a cryptographically secure private signing key and public key;
generating partial signing keys on the basis of the signing key; and
distributing the partial signing keys to the set of registered devices.

3. The method of claim 2, wherein the request comprises a challenge and a partial signature generated on the basis of the challenge and the partial signing key of the device.

4. The method of claim 3, wherein the response from each device comprises a partial signature generated on the basis of the partial signing keys of each device and the challenge.

5. The method of claim 4, wherein the further request comprises the partial signatures of the subset of devices, the challenge and the command.

6. The method of claim 5, comprising:
receiving the further request;
generating a signature on the basis of the partial signatures;
verifying the signature on the basis of the verification key; and
executing the command at the remote device when the signature is successfully verified.

7. The method of claim 1, wherein the set of authorised subsets are determined according to an access structure.

8. The method of claim 1, comprising registering or revoking a device by adding or removing the device from a list of registered devices.

9. The method of claim 8, comprising:
determining whether a received request or response is sent from a device on the list of registered devices; and
blocking the request or response when the device is absent from the list of registered devices.

10. An apparatus comprising:
a data storage arranged to store a list of registered devices and an access structure comprising a set of authorised subsets of the registered devices;
a management module, communicatively coupled to the data storage, to:
notify the set of registered devices, that a request has been received from a device in the set of registered devices, the request comprising a command to be executed at a remote device;
receive responses from a subset of the registered devices; and
forward the request to execute the command at the remote device, wherein the command executes on the remote device in response to the subset of devices being an authorised subset according to the access structure.

11. The apparatus of claim 10, comprising a key management module communicatively coupled to the data storage, to:
generate signing and public keys;
generate partial signing keys on the basis of the signing key; and
distribute the partial signing keys to the set of registered devices;

12. The apparatus of claim 11, wherein the responses from the subset of the registered devices comprise partial signatures generated on the basis of the partial signing keys.

14. The apparatus of claim 13, wherein the management module forwards the partial signatures and/or a combined signature generated on the basis of the partial signatures, for verification with the request.

15. A non-transitory machine-readable storage medium encoded with instructions executable by a processor to:
communicate a request comprising a command for execution at a remote device to a set of registered devices;
process a response to the request from each device in a subset of the set of registered devices;
generate a further request to execute the command; and
communicate the further request to the remote device,
wherein the command executes on the remote device, in response to the subset of devices being an authorised subset of the registered devices;
